(19) United States
(12) Patent Application Publication
(10) Pub. No.: US 2026/0149566 A1
(43) Pub. Date: May 28, 2026

(54) BLOCKCHAIN-ENABLED BROADCAST ENCRYPTION

(71) Applicant: nChain Licensing AG, Zug (CH)

(72) Inventors: Daniel JOSEPH, London (GB); Craig WRIGHT, London (GB)

(21) Appl. No.: 19/123,343

(22) PCT Filed: Oct. 20, 2023
(86) PCT No.: PCT/EP2023/079367

§ 371 Date: Apr. 22, 2025

(30) Foreign Application Priority Data
Oct. 26, 2022 (GB) 2215833.1

(51) Int. Cl. H04L 9/08; H04L 9/00; H04L 9/40

(52) U.S. Cl. CPC H04L 9/0819; H04L 9/50; H04L 63/0428

(57) ABSTRACT

A computer-implemented method of enabling users to access broadcasted messages using blockchain transactions comprising: determining a set of users eligible to access a message; maintaining a key graph comprising a plurality of nodes representing keys, generating an encrypted message; determining a set of encrypted data items; obtaining a message transaction comprising: a respective input associated and signed by each respective user, a respective input associated with and signed by the broadcasting party, a respective output associated with and locked to a respective public key of the respective user and/or a public key of the broadcasting party, and a respective output comprising the set of encrypted data items; causing the message transaction to be submitted to a blockchain network; and broadcasting the encrypted message to at least the set of users.

### CROSS REFERENCE TO RELATED APPLICATIONS

This application is the U.S. National Stage of International Application No. PCT/EP2023/079367 filed on Oct. 20, 2023, which claims the benefit of United Kingdom Patent Application No. 2215833.1, filed on Oct. 26, 2022, the contents of which are all incorporated herein by reference in their entireties.

### TECHNICAL FIELD

The present disclosure relates to a method of enabling users to access encrypted broadcasted messages using blockchain transactions, and to a method of accessing encrypted broadcasted messages.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below.

Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

### SUMMARY

Broadcasting typically refers to the distribution of information to a large, dispersed audience. It typically refers to radio and television communications but fundamentally it is the distribution of ‘the same information’ to multiple parties in one communication. This differs to a peer-to-peer model where communication is expected to be between one party and another.

Broadcasting information has its own unique characteristics and, subsequently, challenges. One may consider the example of the providers of a television subscription service who may want to exclude certain households from being able to access their broadcasted content due to the failure of said households to pay or renew their respective subscriptions. The research area of broadcasting encryption investigates approaches on how this gatekeeping may be accomplished. It devises cryptographic solutions for delivering an encrypted message m over a broadcasting channel in such a way that only qualified users are able to decrypt the message. Note that there are reasons other than lack of payment for wanting to exclude certain recipients from accessing a broadcasted message, e.g. for reasons of security, privacy, confidentiality, (lack of) computing resources, etc.

Access rights are thus dynamic. This dynamism stems from the premise that, in the process of broadcasting messages, new members are expected to earn the right to access the new message while others who were granted access to previous messages may then have their rights revoked for the new message. A successful broadcasting encryption scheme should be able to manage encryption keys, and their updates and distribution, in an efficient way. The set of encryption keys includes the key used to directly encrypt the message to be broadcast as well as other keys involved in making this encryption key available only to the qualified users. Broadcast encryption seeks solutions that efficiently manages these keys while maintaining the integrity of access rights to the message.

The efficiency considerations for broadcast encryption schemes are related to factors such as the:
Number of keys held by the recipients
Number of keys held by the broadcaster
Number of encryptions performed by the broadcaster
Number of communications between broadcaster and recipients.

The present disclosure solves the problem of how to efficiently communicate encryption keys to recipients eligible to access broadcasted messages.

According to one aspect disclosed herein, there is provided a computer-implemented method of enabling users to access broadcasted messages using blockchain transactions, wherein each user is associated with a respective user encryption key, and wherein the method is performing by a broadcasting party and comprises, for a first message: determining a first set of users eligible to access the first message; maintaining a first key graph comprising a plurality of nodes, wherein the key graph comprises a root layer comprising a first root node, followed by one or more inner layers, each inner layer comprising a respective plurality of inner nodes, followed by a leaf layer comprising a plurality of leaf nodes, wherein the root node is a parent node of the respective plurality of inner nodes of a first one of the inner layers, wherein each node of each respective inner layer other than a final inner layer is a respective parent node of one or more respective inner nodes a next inner layer, wherein each inner node of a final one of the inner layers is a respective parent node of one or more leaf nodes of the leaf layer, wherein each node is mapped to a respective encryption key, each leaf node being mapped to a respective user encryption key of the first set of users, wherein the first root node is mapped to a first message encryption key, wherein a respective key mapped to a respective child node is used to encrypt a respective key mapped to a respective parent node; generating a first encrypted message by encrypting the first message with the first message encryption key; determining a first set of encrypted data items, wherein each respective encrypted data item in the first set of encrypted data items comprises one or more respective encryption keys mapped to one or more respective parent nodes of the first key graph, encrypted using a respective encrypted key mapped to a respective child node of the respective parent node of the one or more respective parent nodes of a respective lowest layer of the first key graph, wherein each respective user of the first set of users is configured to decrypt at least one of the respective encrypted data items; obtaining a first message transaction, wherein the first message transaction comprises: a respective input associated with each respective user of the first set of users, wherein the respective input is signed by the respective user, a respective input associated with the broadcasting party, wherein the respective input is signed by the broadcasting party, a respective output associated with each user of the first set of users, wherein each respective output is locked to respective public key of the respective user and/or a public key of the broadcasting party, and a respective output comprising the first set of encrypted data items; causing the first message transaction to be submitted to a blockchain network; and broadcasting the first encrypted message to at least the first set of users.

According to another aspect disclosed herein, there is provided a computer-implemented method of accessing broadcasted messages using blockchain transactions, wherein each user is associated with a respective user encryption key, wherein a broadcasting party maintains a first key graph comprising a plurality of nodes, wherein the key graph comprises a root layer comprising a first root node, followed by one or more inner layers, each inner layer comprising a respective plurality of inner nodes, followed by a leaf layer comprising a plurality of leaf nodes, wherein the root node is a parent node of the respective plurality of inner nodes of a first one of the inner layers, wherein each node of each respective inner layer other than a final inner layer is a respective parent node of one or more respective inner nodes a next inner layer, wherein each inner node of a final one of the inner layers is a respective parent node of one or more leaf nodes of the leaf layer, wherein each node is mapped to a respective encryption key, each leaf node being mapped to a respective user encryption key of the first set of users, wherein the first root node is mapped to a first message encryption key, wherein a respective key mapped to a respective child node is used to encrypt a respective key mapped to a respective parent node, and wherein the method is performing by a first user and comprises: providing, to the broadcasting party, a first input of a first message transaction, wherein the first message transaction comprises a first output locked to a first public key of the first user and/or a public key of the broadcasting party, wherein the first input is signed by the first user; obtaining the first message transaction, wherein the first message transaction comprises an output comprising a first set of encrypted data items, wherein each respective encrypted data item in the first set of encrypted data items comprises one or more respective encryption keys mapped to one or more respective parent nodes of the first key graph, encrypted using a respective encryption key mapped to a respective child node of the respective parent node of the one or more respective parent nodes of a respective lowest layer of the first key graph, obtaining, from the broadcasting party, a first encrypted message generated by encrypting a first message with the first message encryption key; decrypting at least one of the respective encrypted data items, using the respective encryption key used to encrypt the respective encrypted data item, to obtain the one or more respective encryption keys; and decrypting the first encrypted message, using at least the obtained one or more respective encryption keys, to obtain the first message.

The blockchain's structured, transparent, and immutable record of data is advantageous in broadcasting given that any data contained within blockchain transactions is available to any interested party, including the eligible users (i.e. recipients eligible to access a broadcasted message). At the same time broadcasting encryption is considered important to this structured, transparent, and immutable record of data as broadcasters may not want this publicly available data to in fact be available (or at least decipherable) to any interested party.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 schematically illustrates an example tree-based encryption scheme,

FIG. 4 schematically illustrates a leave and join process for an example key graph,

FIG. 5 schematically illustrates an example system for broadcasting encrypt using a blockchain,

FIG. 6 schematically illustrates example transactions for sharing encrypted keys for multiple sessions,

FIG. 7 schematically illustrates further example transactions for sharing encrypted keys for multiple sessions, and

FIG. 8 schematically illustrates example transactions for sharing encrypted keys for multiple sub-sessions.

### DETAILED DESCRIPTION OF EMBODIMENTS

### 1. Example System Overview

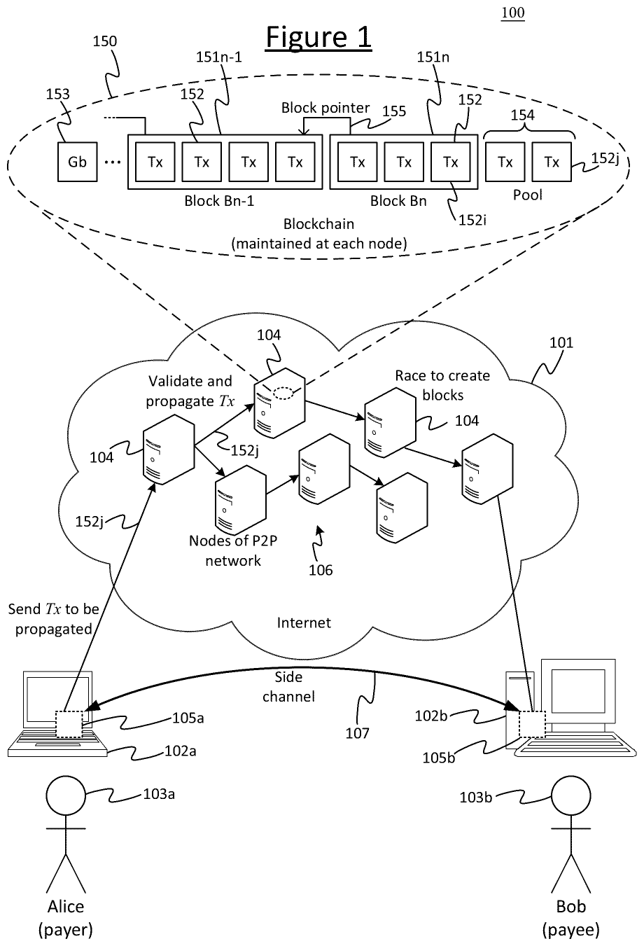

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”.

This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction spends (or “assigns”), wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (or “spent”) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it spends or assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### 2. UTXO-Based Model

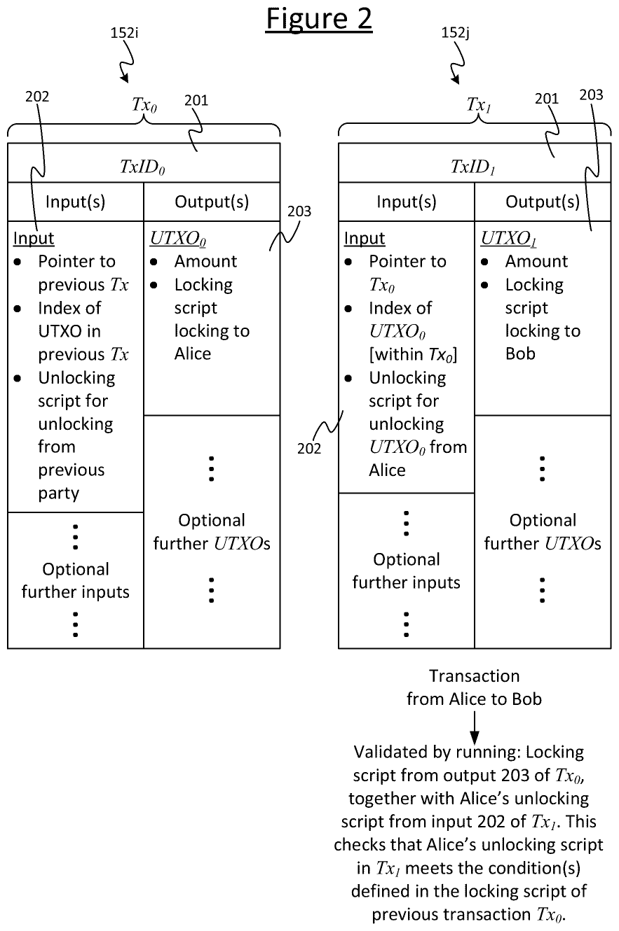

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx”. It takes an amount of the digital asset that is locked to Alice in the output 203 of a preceding transaction 152i in the sequence, and transfers at least some of this to Bob. The preceding transaction 152i is labelled “Tx/” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:
<Sig P_{A}><P_{A}>∥[Checksig P_{A}]
   where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned (or spent) by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 3. Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### 4. Key Graphs

There are existing ways of accomplishing the controlled access requirements of broadcasting encryption. As an example of these consider a group of n members where the broadcaster gives each member Mᵢ a unique decryption key kᵢ. Here, ‘member’ refers to a recipient in the set of entities to whom a message is broadcast. The broadcaster encrypts the message n times, each time with a unique encryption key that corresponds with a decryption key kᵢ. However, in light of aforementioned efficiency factors, one can see how such a scheme is inefficient in terms of key management. This is especially important as the expectation is that there is continued addition and or removal of members from the qualified subset.

Accordingly, more sophisticated schemes have been devised to reduce storage, communications, and encryption redundancies. These include hierarchical schemes where the logN height of the tree reduces previously linear (or worse) computations and storage.

This provides for “higher scalability for secure communications in large dynamically changing groups”. Examples of these key graph hierarchical schemes are provided below.

This section summarises the three versions of the Group Key Management: Key Graphs outlined in Wong, C. K., Gouda, M. and Lam, S. S., 1998. Secure group communications using key graphs. ACM SIGCOMM Computer Communication Review, 28(4), pp. 68-79.

For each version it is assumed that the message being broadcast is encrypted exactly once with a key k_{G}. The description of the scheme is done in the context of the key graph of Error!Reference source not found. and utilising the following notations.

For the tree shown in Error!Reference source not found. each leaf node corresponds to a member Mᵢ and the key that labels each node is assumed to have been securely communicated to (or be calculable) all the descendant leaf nodes/members.

U is a finite and nonempty set of group members, K is a finite and nonempty set of keys, and R⊂U×K is a binary member-key relation.

The broadcaster (B) knows the member set U and the key set K, and is responsible for maintaining the member-key relation R. There are two functions associated with each secure group (U, K, R):
keyset(Mᵢ)={k|(Mᵢ, k)∈R}, which is the set of all keys held by member M, and
keyset(Ø)=Ø;
userset(k)={Mᵢ|(Mᵢ, k)∈R}, which represents the set of all members holding the key k.

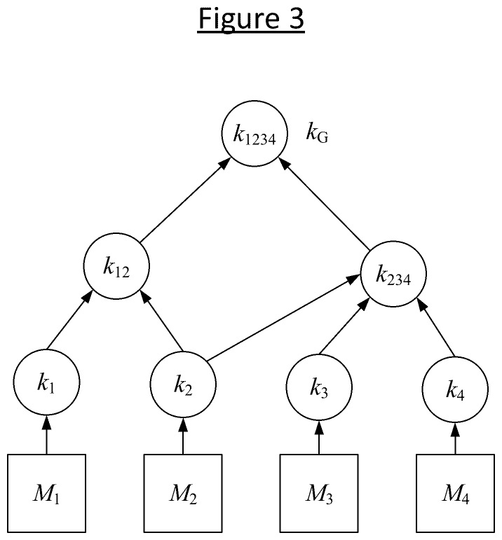

To further clarify, FIG. 3 presents a key graph, where the following relations apply

$$keyset ( {M}_{2} ) = \{ {k}_{12} , {k}_{234} , {k}_{1234} , \}$$

$$keyset ( {M}_{3} ) = \{ {k}_{234} , {k}_{1234} \}$$

$$userset ( {k}_{1} ) = \{ {M}_{1} \} ,$$

$$userset ( {k}_{12} ) = \{ {M}_{1} , {M}_{2} \} ,$$

and where k_{i . . . j} is the key shared only by members {Mᵢ, . . . , Mⱼ}.

Also note that
{k_{α . . . ω}}ₖ_{ₑ} means that the set of keys ‘k_{α} to k_{ω}’ are collectively encrypted by the key kₑ.
and that, in a tree, the key of a child node is needed to decrypt the key of the parent node.

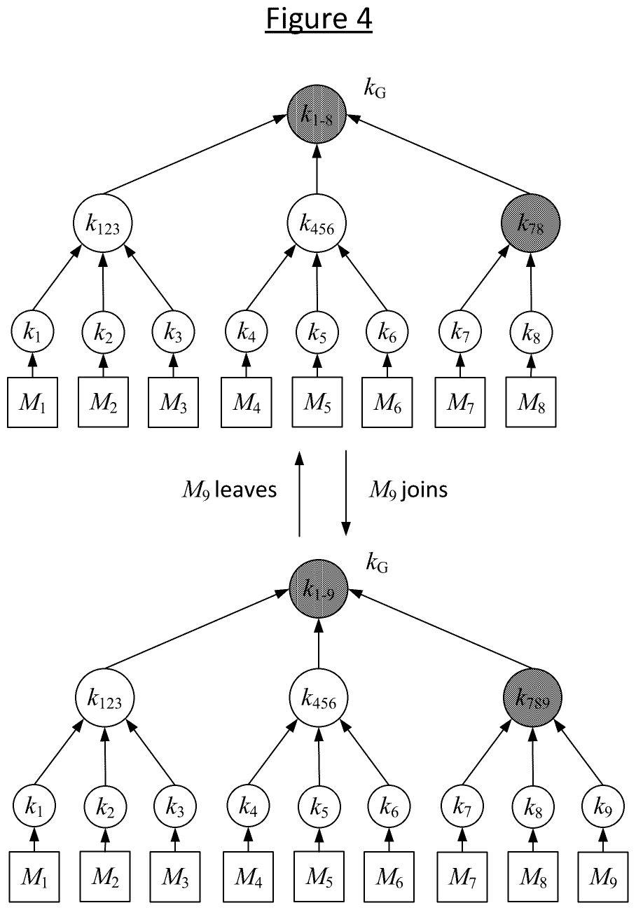

Key management schemes are defined or differentiated based on how they manage the rekeying process. Rekeying comprises two main processes: a ‘join’—where a new user is given access to future broadcast messages, and a ‘leave’—where access to future messages is revoked for a previous member. For GKM: Key Graphs, there are at least three ways of rekeying (User-oriented, Key-oriented, Group-oriented). Each is described with respect to FIG. 4 where a shaded node represents a key that has to be changed (and communicated to descendant members) in light of a Join or Leave event happening.

### 4.1 User-Oriented Strategy

For User-oriented Strategy, the intention is for, within the rekeying process, the new keyset

$${K}_{i}^{new}$$

of a user Mᵢ are all included in a single rekeying message. This strategy is applicable where the broadcaster wants to minimise the number of communications it makes to each member.

Consider a join operation where M₉ is added as a legitimate recipient. The following communiqués are made

$$B \to \{ {M}_{1} , … , {M}_{6} \} : {\{ {k}_{1 - 9} \}}_{{k}_{1 - 8}}$$

$$B \to \{ {M}_{7} , {M}_{8} \} : {\{ {k}_{1 - 9} , {k}_{789} \}}_{{k}_{78}}$$

$$B \to \{ {M}_{9} \} : {\{ {k}_{1 - 9} , {k}_{789} \}}_{{k}_{9}}$$

A communiqué is a message sent by the broadcaster B to a user or set of users. E.g., the communiqué B→{M₁, . . . , M₆}: {k₁₋₉}ₖ_{_{1-B}} means that the broadcaster sent to the set of users {M₁, . . . , M₆} the key k₁₋₉ and this key was encrypted using the key k₁₋₈.

First note that the addition of member M₉ means that keys k₁₋₈ and k₇₈ have to be replaced by keys k₁₋₉ and k₇₈₉ respectively. New keys are generated by the broadcaster, B, the broadcaster responsible for key management and broadcasting messages. Importantly key management includes the generation of new keys.
For users M₁ to M₆ the rekeying process only needs to provide them with the new key k₁₋₉. Given that that this subset of members all previously possessed the key k₁₋₈ it can now be used to encrypt the new key k₁₋₉.
For users M₇ to M₈ the rekeying process needs to provide them with the new keys k₁₋₉ and k₇₈₉. Given that both members previously possessed the key k₇₈ it is used to encrypt the new keys k₁₋₉ and k₇₈₉.
Meanwhile for the new member M₉ the rekeying process also needs to provide the member with the new keys k₁₋₉ and k₇₈₉. Its newly granted personal key k₉ is used to encrypt the new keys k₁₋₉ and k₇₈₉.

In the case of a leave, e.g. user M₉ leaves, the following communiqués are made

$$B \to \{ {M}_{1} , {M}_{2} , {M}_{3} \} : {\{ {k}_{1 - 8} \}}_{{k}_{123}}$$

$$B \to \{ {M}_{4} , {M}_{5} , {M}_{6} \} : {\{ {k}_{1 - 8} \}}_{{k}_{456}}$$

$$B \to \{ {M}_{7} , \} : {\{ {k}_{1 - 8} , {k}_{78} \}}_{{k}_{7}}$$

$$B \to \{ {M}_{8} \} : {\{ {k}_{1 - 8} , {k}_{78} \}}_{{k}_{8}}$$

We first note that the replacement of member M₉ means that keys k₁₋₉ and k₇₈₉ have to be replaced by keys k₁₋₈ and k₇₈ respectively. In addition
For members M₁ to M₃ the rekeying process provides them with the new key k₁₋₈. Given that that subset of members all previously possessed the key k₁₂₃ it is used to encrypt the new key k₁₋₈. Note that the group M₁ to M₆ cannot jointly be communicated to since the key they had in common was k₁₋₉ which is now compromised given M₉'s departure.
For users M₄ to M₆ the rekeying process also provides them with the new key k₁₋₈ however it is encrypted with the key k₄₅₆.
For members M₇ to M₈ the rekeying process needs to provide them with the new keys k₁₋₈ and k₇₈. However, each must be given this pair of keys in separate encryptions as their previous common key was k₇₈₉ which is compromised. Each are given the pair of new keys encrypted using their own personal keys.

### 4.2 Key-Oriented Strategy

In the case of the key-oriented strategy, the intention is for each communique to contain only one key. An application of such a design is where one wants to target a member with only the specific keys that the member is entitled to receive. Further the set of users that may interpret the key should be maximised but not compromise the security of the system. With reference to the FIG. 4, consider a join (user M₉) is added as a legitimate recipient.

The following communiqués are made

$$B \to \{ {M}_{1} , … , {M}_{8} \} : {\{ {k}_{1 - 9} \}}_{{k}_{1 - 8}}$$

$$B \to \{ {M}_{9} \} : {\{ {k}_{1 - 9} \}}_{{k}_{9}}$$

$$B \to \{ {M}_{7} , {M}_{8} \} : {\{ {k}_{789} \}}_{{k}_{78}}$$

$$B \to \{ {M}_{9} \} : {\{ {k}_{789} \}}_{{k}_{9}}$$

Note that the addition of member Mᵢ means that keys k₁₋₈ and k₇₈ have to be replaced by keys k₁₋₉ and k₇₈₉ respectively.
It is necessary to communicate the new key k₁₋₉ to all the previous members {M₁, . . . , M₈} so this is done using their previous common key k₁₋₈. The new key is also communicated to the new member M₉ using its personal key k₉.
It is also required that the new key k₇₈₉ is communicated to all the members M₇ and M₉. This is done using their previous common key k₇₈. The key k₇₈₉ is also communicated to the new member M₉ using its personal key k₉.

In the case of a leave (M₉ leaves) the following communiqués are issued.

$$B \to \{ {M}_{1} , {M}_{2} , {M}_{3} \} : {\{ {k}_{1 - 8} \}}_{{k}_{123}}$$

$$B \to \{ {M}_{4} , {M}_{5} , {M}_{6} \} : {\{ {k}_{1 - 8} \}}_{{k}_{456}}$$

$$B \to \{ {M}_{7} \} : {\{ {k}_{78} \}}_{{k}_{7}}$$

$$B \to \{ {M}_{7} \} : {\{ {k}_{1 - 8} \}}_{{k}_{78}}$$

$$B \to \{ {M}_{8} \} : {\{ {k}_{78} \}}_{{k}_{8}}$$

$$B \to \{ {M}_{8} \} : {\{ {k}_{1 - 8} \}}_{{k}_{78}}$$

The new keys are k₁₋₈ and k₇₈. The former cannot be communicated to the set {M₁, . . . , M₆} using k₉ as it is compromised, so it is sent to the subsets {M₁, M₂ M₃} and {M₄, M₅, M₆} individually (encrypted by the appropriate common key).
Both the members M₇ and M₈ given their new parent key k₇₈ as encrypted by their personal keys. At the same time, they receive the new root key (k_{G}=k₁₋₈) as encrypted by the new key k₇₈.

### 4.3 Group-Oriented Strategy

For the group-oriented strategy, the intention is for each communique to contain as many keys as possible. This solution limits the number of encryptions being made overall. With reference to FIG. 4, consider a join (user M₉) is added as a legitimate recipient. The following communiqués are made

$$B \to \{ {M}_{1} , … , {M}_{8} \} : {\{ {k}_{1 - 9} \}}_{{k}_{1 - 8}} , {\{ {k}_{789} \}}_{{k}_{78}}$$

$$B \to \{ {M}_{9} \} : {\{ {k}_{1 - 9} , {k}_{789} \}}_{{k}_{9}}$$

Note that the addition of member Mᵢ means that keys k₁₋₈ and k₇₈ have to be replaced by keys k₁₋₉ and k₇₈₉ respectively.
In one communique the new keys k₁₋₉ and k₇₈₉ are sent to all the previous members {M₁, . . . , M₈}. This is done encrypting k₁₋₉ using the key k₁₋₈ and encrypting k₇₈₉ using the key k₇₈. Note that some members will receive in that communique keys that they don't need. As an example, members Mᵢ to M₆ have no need for the key k_{7,9}.
New member M₉ is given both the keys k₁₋₉ and k₇₈₉ in one communiqué. These keys are ‘combined’ and encrypted using M₉'s personal key.

In the case of a leave (M₉ leaves) the following communiqués are issued.

$$B \to \{ {M}_{1} , … , {M}_{8} \} : {\{ {k}_{1 - 8} \}}_{{k}_{123}} , {\{ {k}_{1 - 8} \}}_{{k}_{456}} , {\{ {k}_{1 - 8} \}}_{{k}_{78}} , {\{ {k}_{78} \}}_{{k}_{7}} , {\{ {k}_{78} \}}_{{k}_{8}}$$

The broadcaster B constructs and sends out rekeying messages to all remaining members {M₁, . . . , M₈}, using appropriate keys to encrypt different new keys, with the goal to minimize the encryption cost by choosing keys shared by as many members as possible. When a member receives the rekeying message, it uses the keys in its keyset to extract those new keys that it is supposed to know, while preventing it from knowing other new keys that should not be exposed to it.

### 5. Broadcast Encryption Using Blockchain

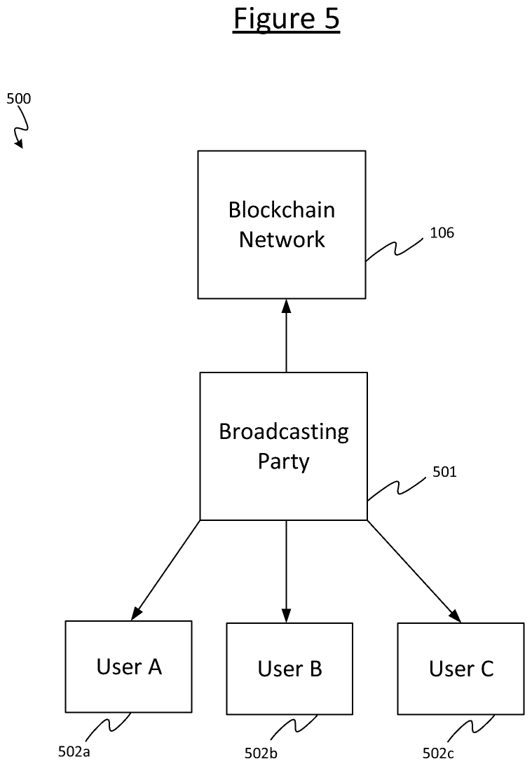

Embodiments of the present disclosure provide an efficient mechanism for efficiently and securely communicating encryption keys to eligible recipients. FIG. 5 illustrates an example system 500 for implementing the disclosed embodiments. As shown, the example system 500 comprises a broadcasting party 501, a plurality of recipient parties 502 (labelled “User A”, “User B”, etc.) and one more nodes 104 of a blockchain network 106. Whilst only three recipients 502a, 502b, 502c are shown in FIG. 5, in general the system 500 may comprise any number of recipients. The broadcasting party 501 may be an individual user, a group of users, an organisation, a company, a government body, etc. In general, the broadcasting party 501 and each recipient 502 operates computing equipment similar to that described above with reference to Alice 103a and Bob 103b. Moreover, the broadcasting party 501 and each recipient 502 may be configured to perform some or all of the actions described above as being performed by Alice 103a and/or Bob 103b.

The broadcasting party 501 is configured to generate, or at least obtain from another party, messages to be broadcast to eligible recipients 501. Each message contains data. The data may include media, such as images, audio, and/or video. The data may include documents. The messages may be sent in sessions. One or more messages may be sent during a first session, one or more messages may be sent during a second session, and so on. The messages sent during successive sessions may or may not be related. In some examples, each session consists of a single message.

The set of recipients 502 eligible to access the messages of a particular session may change from session to session. That is, a recipient (e.g. User B 502b) may be eligible to access messages of a first session, but not of a second session. User B 502c may then be eligible to access messages of a third session. As another example, a recipient (e.g. User A 502a) may be eligible to access messages of all sessions.

For each session, the broadcasting party 501 uses a “message encryption key” (sometimes referred to herein as a “session encryption key”) to encrypt the message(s) of a given session. Messages sent during successive sessions may be encrypted with the same message encryption key if the set of eligible recipients does not change between sessions. However, if the set of eligible recipients does change between sessions, the message encryption key is changed, thus preventing ineligible recipients from accessing the messages of the later session. For instance, if the set of eligible recipients changes between the first and second sessions, all messages of the first session are encryption using a first message encryption key, and all messages of the second session are encrypted using a second, different message encryption key. In some examples, the message encryption key is changed with every session.

Each recipient 502 is associated with (i.e. has access to, e.g. by storing in memory) their own “user encryption key”. That is, the user encryption key is an encryption key that only a given recipient 502 has access to. In some examples, the encryption keys are symmetric encryption keys. In other examples, the encryption keys are asymmetric keys. In the case of asymmetric keys, the notation kᵢ represents the asymmetric key pair kᵢ=(Pᵢ, vᵢ) where the public key Pᵢ is the key being used when the present disclosure describes a key “kᵢ is being used for encrypting”, and the private key vᵢ is the key being used when the present disclosure describes a key “kᵢ is being used for decrypting”.

The broadcasting party 501 maintains (e.g. generates or receives) a key graph. Key graphs have been described above in section 4. The key graph comprises a plurality of nodes and directed edges. Each node represents an encryption key. Each edge represents that a key mapped to a node is used to encrypt a key mapped to another node (if the edges are directed to a root node, as shown in the example of FIG. 3). Alternatively, each edge represents a key that is mapped to a node is required to decrypt a key mapped to another node (if the edges are directed away from a root node). The key graph comprises a root node mapped to a message encryption key, e.g. the first message encryption key. The key graph then comprises one or more further layers of nodes, each layer comprising two or more nodes. A final layer is referred to as a leaf layer. The leaf layer comprises a plurality of leaf nodes, each mapped to a different user encryption key. The root node is a parent node of the nodes of the next layer, which are parent nodes of the child nodes of the next layer, and so on.

Starting from a first layer following the root layer (i.e. a first inner layer of the key graph adjacent to the root layer), each key mapped to a node in the first layer is used to, separately, encrypt the message encryption key. Here, separately means that if there are two nodes in the first layer, two separate encrypted keys are produced, one is the message encryption key encrypted with a first encryption key of the first layer and the other is the message encryption key encrypted with a second encryption key of the first layer. For example, referring to FIG. 3, key k₁₂ is used encrypt key k₁₂₃₄ to produce {k₁₂₃₄}k₁₂, and key k₂₃₄ is used to encrypt key k₁₂₃₄ to produce {k₁₂₃₄}k₂₃. For the second layer (i.e. the next layer after the first layer), each encryption key mapped to a node of the second layer is used to, separately, encrypt at least one of the encrypted keys produced as a result of the keys mapped to the nodes of the first layer encrypting the message encryption key. For example, referring again to FIG. 3, key k₁ is used to encrypt encrypted key {k₁₂₃₄}k₁₂ to produce {{k₁₂₃₄}k₁₂}k₁. This process is repeated until the user encryption keys have been used to encrypt an encrypted key produced as a result of the keys mapped to the nodes of the final inner layer being used to encrypt encrypted keys. Referring to FIG. 3, this means that to decrypt a message encrypted with message encryption key k₁₂₃₄, recipient M₁ uses k₁ to decrypt k₁₂, k₁₂ to decrypt k₁₂₃₄, and k₁₂₃₄ to decrypt the message.

The broadcasting party 501 generates a first encrypted message by encrypting a first message with the first message encryption key. The broadcasting party 501 broadcasts the first encrypted message to all recipients 502 (or at least recipients eligible to access the first message). Options for broadcasting the first encrypted message are discussed below.

The broadcasting party 501 determines a first set of eligible recipients. The first set of eligible recipients may be known in advance, e.g. it may include all recipients, or all participants that have registered for access (before a certain time, or by performing a certain action). Alternatively, as discussed in more detail below, the first set of eligible recipients may be determined based on the inputs to a blockchain transaction.

Regardless of how the first set of eligible recipients is determined, the broadcasting party obtains (by at least partly generating) a first blockchain transaction. The first blockchain transaction comprises, for each eligible recipient, a respective input signed by that recipient. The first blockchain transaction also comprises, for each eligible recipient, a respective output locked to a respective public key of the recipient and/or a public key of the broadcasting party 501. Multi-signature locking scripts may be used in the case that the output is locked to two public keys. In some examples, the signature (corresponding to a recipient's public key) that is used to sign a recipient's input also signs the recipient's output. The first blockchain transaction further comprises an input signed by the broadcasting party 501 (this may be the last input to be signed, such that the corresponding signature signs the whole transaction). In some example, the signature used to sign the broadcaster's input may be a threshold signature, generated by multiple parties in collaboration. The first blockchain transaction also comprises an output comprising a first set of encrypted data items. Each encrypted data item comprises one or more encrypted encryption keys.

In some examples, the eligible recipients are determined based on the inputs of the first transaction. That is, a first input signed by a recipient 502 is interpreted as that recipient being eligible to access the first message. Recipients 502 may send signed inputs (and corresponding output) to the broadcasting party 501.

The first set of encrypted data items is determined based on the first set of eligible recipients and the encryption keys of the graph that each recipient currently has access to. If the first message encryption key is the initial encryption key, the first set of encrypted key may include, for each eligible recipient, the first message encryption key encrypted with one or more encryption keys of the key graph, including the recipient's user encryption key, e.g. {{k₁₂₃₄}k₁₂}ₖ_{₁} for recipient M₁ of the key graph shown in FIG. 3. If the first message encryption key is not the initial encryption key, the first set of encryption keys may be determined based on one of the key strategies described in section 4. Regardless, each encrypted data comprises one or more encryption keys of the key graph, encrypted with another encryption key of the key graph. The one or more encryption keys comprise a respective node from a respective layer, e.g. a parent node and its child node, or a parent node followed by its child node, followed by its child node. The encryption key used to encrypt the one or more encryption keys is mapped to a child node of whichever key of the one or more encryption keys is mapped to the child node of the lowest level of the key graph. Here, “lowest” means closest to the leaf layer.

The first blockchain transaction is sent to the blockchain network 106, either directly or via an intermediary. In some examples, the first encrypted message is included in an output of the first blockchain transaction (e.g. the same output as the encrypted data items), thus broadcasting the first encrypted message. The first encrypted message may be broadcast using any suitable technique, such as over separate channels to recipients, or over a common channel, e.g. a radio channel, or via the Internet.

In some examples, for each eligible recipient, the first blockchain transaction includes an additional input signed by that recipient. This input may be used to pay for access to the first message. In other words, to be eligible to access the first message, a participant may be required to sign two separate inputs of the first blockchain transaction.

Assuming the first recipient 502a is one of the first set of recipients, and therefore eligible to access the first message, the first recipient 502a obtains the first blockchain transaction and the first encrypted message (e.g. received over a broadcast channel or extracted from the first blockchain transaction). The first recipient 502a extracts at least one of the first set of encrypted data items from the first blockchain transaction, decrypts the encrypted data item(s) to obtain one or more encryption keys, and uses the one or more encryption keys to decrypt the first encrypted message. Depending on which keys the first recipient 502a has access to at the time of obtaining the first encrypted message will determine which of the first encrypted data items can be decrypted. For instance, if one of the first encrypted data items is encrypted with the first recipient's user encryption key, the first recipient uses their user encryption key to decrypt the first encrypted data item. If the first recipient 502a has access to an encryption key at a higher layer in the key graph and one of the first encrypted data items is encrypted with that encryption key, then the first recipients uses that encryption key to decrypt the first encrypted data item.

Each eligible recipient performs similar actions to the first participant 502a. The first set of encrypted data items are determined such that each eligible participant can decrypt at least one of the encrypted data items, and use the resulting one or more encryption keys to decrypt the first encrypted message.

If multiple encrypted messages are sent during the first session and encrypted with the same first message encryption key, the eligible participants may decrypt the multiple messages in the same way in which they decrypt the first encrypted message.

For the next session (the second session), the broadcasting party 501 encrypts a second message using a second message encryption key to generate a second encrypted message. If no participants have either left or joined since the previous session, the second message encryption may be the same as the first message encryption key. In contrast, a different key is required if one or more participants have joined or left since the previous session. The broadcasting party 501 determines a second set of eligible participants that are eligible to access the second message. The second set of eligible participants differs from the first set of eligible recipients. One or more participants of the first set may no longer be eligible to receive messages of the second session. Additionally or alternatively, one or more participants that were not included in the first set and thus not eligible to receive message of the first session may now be eligible to receive the message of the second session.

The second encrypted message is broadcast to at least the second set of participants. In some examples, the second encrypted message is broadcast to all participants.

The broadcasting party 501 obtains (e.g. at least partly generates) a second blockchain transaction. The second set of eligible participants may be determined based on the inputs to the second blockchain transaction. That is, each eligible participant may have an associated input signed by that participant. The inputs may be provided by the eligible participants. In some examples, a participant that was eligible to receive messages of the first session and thus had an output locked to their public key included in the first blockchain transaction, may spend that output as an input to the second blockchain transaction. In some examples, the broadcasting party 501 may determine that a previously eligible recipient is no longer eligible based on the status of the respective outputs of the first blockchain transaction. If an output associated with a recipient (i.e. locked to the public key of that participant) is spent by an input of a transaction other than the second blockchain transaction, the broadcasting party 501 interprets said spending as a revocation of that participants eligibility to access the messages of the second session. The output may be spent by the recipient and/or by the broadcasting party 501. That is, the broadcasting party may generate a transaction that spends a recipient's output of the first blockchain transaction in order to revoke the recipient's eligibility. As another example, the broadcasting party 502 may deem that a recipient is no longer eligible to access messages if the recipient has not spent their output of the first blockchain transaction using an input of the second blockchain transaction within a predetermined time period.

Like the first blockchain transaction, the second transaction includes a respective output for each respective input signed by a respective recipient of the second set of eligible recipients. The respective output is locked to the recipient's public key and/or the broadcasting party's public key. The second transaction also includes an input signed by the broadcasting party 501. The broadcasting party's input may spend the output of the first transaction locked to the broadcasting party's public key.

The broadcasting party 501 determines a second set of encrypted data items and includes the second set of encrypted data items in an output of the second blockchain transaction. The second blockchain transaction may also include the second encrypted message.

To determine the second set of encrypted data items, the broadcasting party 501 updates the first key graph, thus generating a second key graph. The first key graph is updated based on the changes between the first and second sets of eligible recipients. The leaf nodes corresponding to the user encryption keys of those recipients of the first set that are no longer eligible are removed from the key graph. Similarly, new leaf nodes corresponding to the user encryption keys of newly eligible recipients are added to the key graph. One or more inner nodes are added to and/or removed from the key graph based on the addition and/or removal of the leaf nodes. Similarly, the root node corresponding to the first message encryption key is replaced with a root node corresponding to the second message encryption key. A simplified example of updating a key graph is shown in FIG. 4 and discussed above. The second set of encrypted data items is determined based on which one encryption keys are available to the eligible recipients. Newly eligible recipients may require different (e.g. more) encryption keys than those that were previously eligible and are still eligible. For example, referring to FIG. 4, if the first recipient 502a (e.g. user M₁) is still eligible to access the messages of the second session and a new participant (user M₉) joins, the first recipient (M₁) requires the encryption key k₁₋₉, i.e. the second message encryption key, whereas the new participant (M₉) requires encryption key k₇₈₉ and the message encryption key k₁₋₉. A first one of the encrypted data items may be key k₁₋₉ encrypted with key k₁₂₃, whereas a second one of the encrypted data items may be key k₇₈₉ and key k₁₋₉ encrypted with key k₉.

The second set of encrypted data items may also be determined based on a key strategy implemented by the broadcasting party 501. That is, the broadcasting party may determine which keys to encrypt and with which keys to use for the encryption, to generate the second set of encrypted data items, based on a particular key strategy, such as one the strategies described in section 4: user-orientated, key-orientated, or group orientated.

Like the first transaction, once the second blockchain transaction is generated and signed, it is sent to the blockchain network, either directly by the broadcasting party 501 or by an intermediary.

Once the second blockchain transaction is recorded on the blockchain 150, the eligible recipients (e.g. the first recipient 502a) extract the relevant encrypted data items, decrypt one or more of the encrypted data items, and use the resulting encryption key(s) to decrypt the second encrypted message.

The examples above have so far assumed that all of the encrypted data items (i.e. encrypted encryption keys) that all of the eligible recipients require to decrypt an encrypted message are contained within a single transaction. Instead, in some examples, the broadcasting party 501 may generate multiple transactions per session. Each transaction contains respective inputs for a respective subset of the eligible recipients. The subsets may or may not be exclusive. For each respective subset of eligible recipients, the broadcasting party 501 determines a respective subset of encrypted data items and includes that subset of encrypted data items in a transaction. The subsets of encrypted data items may be generated based on the eligible recipients in each subset and the chosen key strategy. The encrypted data items needed by a given recipient may all be included in a single transaction, or be spread across multiple transactions. This is described in more detail in section 6 below.

### 6. Example Blockchain Broadcast Subscription Implementation

This section describes an example system where the blockchain 150 is utilised in the rekeying processes of broadcasting encryption. More specifically the system may perform the functionalities of:
storing encrypted keys,
representing legitimate users
handling renewal of subscriptions

Rekeying is where a member is either added (Join) to the set of eligible members or a member removed (Leave) from the set of eligible members. Both cases are explored in the contexts of:
Dust or Nominal Fee (Here the payment for eligibility is not included in the session transaction)
On-block paid subscription (Payment for eligibility is included in the session transaction)

### 6.1 Off-Chain Subscription

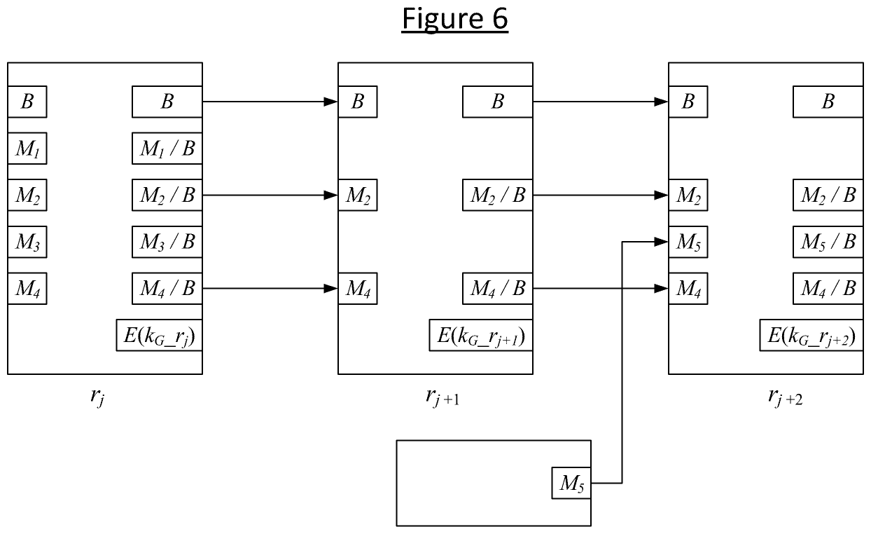

A ‘session’ represents a broadcast to a set of legitimate users. The proposed system is described through the use of the three re-keying sessions of FIG. 6. In FIG. 6 three sessions are represented: rⱼ, rⱼ₊₁, and rⱼ₊₂. Each session has a corresponding blockchain transaction Tᵣⱼ, Tᵣⱼ₊₁ and Tᵣⱼ₊₂. Each transaction has at least nⱼ₊₁ inputs and at least nⱼ₊₂ outputs, where nⱼ is the number of eligible members for that particular broadcasting session rⱼ.

At least one of the inputs of a transaction Tᵣ is from the broadcaster B; the other at least n inputs are each from a corresponding eligible member Mᵢ. An input being from a member translates to the member giving approval of their corresponding member output (shown (visually) opposite). This output includes the spending conditions (locking script) and the amount of coins being transferred.

The locking script is expected to have conditions that allows either the broadcaster B or the member Mᵢ to spend the member output. The amount of coins being transferred must be greater than the member's proportion of the transaction mining fee. The SIGHASH value for member Mᵢ's input is chosen such that Mᵢ only signs their corresponding output. (SIGHASH SINGLE).

Member Mᵢ spending its member output of session transaction Tᵣ as the input to session transaction Tᵣ₊₁ indicates that Mᵢ is consenting in having access to broadcasting session rⱼ₊₁. On the other hand, if a member Mᵢ's output is not spent as the input to session transaction Tᵣ₊₁ (by a certain deadline) then this indicates that Mᵢ should not be eligible to access the broadcasting session rⱼ₊₁.

Another input that is included in a session transaction is that of the broadcaster B. This input has its corresponding broadcaster output. When the broadcaster B signs the input of a session transaction Tᵣ this gives final approval of all the contents of the session transaction. As such, all eligible members should have inspected and signed their corresponding outputs beforehand.

In addition, an OP_RETURN output is also included in session transaction Tᵣ. This output is dedicated to storage of the appropriately encrypted keys that would enable the eligible members to be able to decipher the key

$${k}_{G}^{{r}_{j}}$$

(Recall that key

$${k}_{G}^{{r}_{j}}$$

is the key utilised to encrypt the broadcasted message of session rⱼ). This set of encrypted keys (represented as

$$E ( {k}_{G}^{{r}_{j}} )$$

depend on the key-management solution that would have previously been decided on (see options in section 4). The system is agnostic of the chosen key-management solution. These encrypted keys are placed within the OP_RETURN output by the broadcaster B, based on the set of members the broadcaster has deemed as having successfully met the criteria for eligibility. Eligibility is based on their on-chain or off-chain action. Other miscellaneous metadata may be included within this output. Examples of metadata content include: the value rⱼ or other session identifier, date, title of content being broadcast, etc. The metadata content may even include the encrypted message m to be broadcast for that particular session rⱼ.

When broadcaster B is satisfied with:
his broadcaster output,
the member outputs of all members,
all members have signed their inputs
the inclusion of the appropriate encrypted keys in the OP_RETURN output

Then the broadcaster B signs his input for session transaction Tᵣ. The SIGHASH flag for broadcaster B's input is chosen such that the sections of the transaction that B signs include all outputs of the session transaction. After B has signed his input then the session transaction Tᵣ is submitted to the blockchain

### 6.1.1 Rekeying

Where the subscription payment is not done within the session transaction, the script that locks the participant's corresponding output (i.e. the output located at the same index as the participant's input) contains conditional statements that would enable either the broadcaster B or a member Mᵢ to spend the member output. Different conditions are such that either of the following scenarios can be accommodated:
If a member output of session transaction Tᵣ is spent by either the broadcaster B or the member Mᵢ in a non-session transaction ( ), this indicates that member Mᵢ's subscription to the broadcast has been revoked i.e. that member Mᵢ is not eligible for broadcast session rⱼ₊₁.
If a member output of session transaction Tri is spent by the member Mᵢ in a session transaction Tᵣ_{ⱼ₊₁}, this indicates that the member Mᵢ has renewed its subscription to the broadcast session rⱼ₊₁ and the member is eligible for broadcast session rⱼ₊₁.

### 6.1.1.1 Rekeying: Leave

Here explicit attention is given to a Leave. (i.e., where one or more members, previously eligible for broadcast session rⱼ, have had their access to session rⱼ₊₁ revoked. This is illustrated in FIG. 6 as the transition between session rⱼ and rⱼ₊₁. In said scenario two members, M₁ and M₃ are deemed as not being eligible for session rⱼ₊₁.

A member Mᵢ leaving after session rⱼ has the responsibility of spending their member output in a non-session transaction before a time tⱼ. This is a formal declaration by the member that they are requesting exclusion from session rⱼ₊₁. This time tⱼ is a mutually agreed-upon time by the broadcaster B and the members {Mᵢ}. After time tⱼ the broadcaster is free to consider the member Mᵢ as being ineligible for session rⱼ₊₁, and submit the session transaction Tᵣ_{ⱼ₊₁} with the appropriate metadata in the OP_RETURN output.

Recall that either the member Mᵢ or broadcaster B can spend Mᵢ's member output for session Tᵣ_{ⱼ}, therefore broadcaster B can spend the output as the input of Tᵣ_{ⱼ₊₁}. However, this has no value to broadcaster B in coins (as only dust is being paid) or the actual broadcast.

### 6.1.1.2 Rekeying: Join

In the case of a Join, members previously ineligible for broadcast session rⱼ, will have their access to session rⱼ₊₁ granted. This is illustrated in FIG. 6 as the transition between session rⱼ₊₁ and rⱼ₊₂. In said scenario a new member M₅ (ineligible to session rⱼ₊₁) has satisfied the requirements (off block) to be eligible for session rⱼ₊₂. A new input and its corresponding member output are included in Tᵣ_{ⱼ₊₂} which member is to sign. New members (M₅ in this instance) are required to sign their input for the session transaction Tᵣ_{ⱼ₊₂} in advance of the submission to the blockchain of said transaction (more specifically . . . in advance of tⱼ₊₁). The session transaction Tᵣ_{ⱼ₊₂} is submitted with the appropriate metadata in the OP_RETURN output.

### 6.1.1.3 Session Transaction

An example of a session transaction Tri is shown below in Table 1. Special attention is given to the sighash types. For each eligible member, their input is signed using a SIGHASH_SINGLE designation. This means that the member's input signature accounts for only the output in the equivalent index as the member's input. Utilising this restriction, the member may sign the transaction as long as they are satisfied with the output script as well as the value of their corresponding output. The member can then pass their signed component of the transaction securely to the broadcaster B, without any fear that any other party may alter the value and output conditions. After collecting each member's signed contributions, the broadcaster signs his input under the SIGHASH_ALL designation. By doing this the broadcaster ensures that, not just his output, but that the outputs of the eligible members are also ‘correct’ and included (as well as the OP_RETURN output containing the encrypted keys of the rekeying). The broadcaster being the last to sign prevents the members being privy to the encrypted keys of the metadata before the submission of the session transaction to the blockchain network.

TABLE 1
TxIDᵣ_{ⱼ}

| Inputs | | Outputs | |
|---|---|---|---|
| Info | Script | Value | Script |
| x_{B} BSV | < Sig(P_{B})> <P_{B}> | y_{B} BSV | OP_DUP OP_HASH160 |
| SIGHASH_ALL | | | H(P_{B}) OP_EQUALVERIFY |
| | | | OP_CHECKSIG |
| ${x}_{{M}_{1 , {r}_{j}}} BSV$ SIGHASH_SINGLE | < Sig(P_{M}_{₁})> | ${y}_{{M}_{1 , {r}_{1}}} BSV$ | OP_1 <P_{M}_{₂}> <P_{B}> OP_2 CHECKMULTISIG |
| ${x}_{{M}_{2 , {r}_{j}}} BSV$ SIGHASH_SINGLE | < Sig(P_{M}_{₂})> | ${y}_{{M}_{2 , {r}_{1}}} BSV$ | OP_1 <P_{M}_{₂}> <P_{B}> OP_2 CHECKMULTISIG |
| . | . | . | . |
| . | . | . | . |
| . | . | . | . |
| ${x}_{{M}_{n , {r}_{j}}} BSV$ | $〈 Sig ( {P}_{{M}_{{n}_{j}}} ) 〉$ | | $OP\_ 1 〈 {P}_{{M}_{{n}_{j}}} 〉 〈 {P}_{B} 〉 OP\_ 2$ |
| SIGHASH_SINGLE | | | CHECKMULTISIG |
| | | ≈0BSV | OP_FALSE OP_RETURN |
| | | | <Re-keying metadata> |
| | | | <other metadata> |

### 6.1.1.4 Coins and Subscription

In this system a member re-subscribes for each session by signing the input of the session transaction. Even if the subscription is ‘free’ the fact that the member output is spent in subscribing to each session (in a chained sequence), means that the original contribution by the member must be:
sufficient to pay for k sessions. As an example, k=12 for a one-year subscription, where each month has a corresponding session transaction.
or replenished via a secondary input by the applicable member before each session renewal.

For nominal fee, consider the example transaction shown in Table 1, assuming the session transaction shown is the first, i.e., j=1. In such an instance the input amount for member Mᵢ would be

$${x}_{{M}_{1 , {r}_{1}}} = k \times mem\_fee$$

where mem_fee, is the cost apportioned to each member for the submission of the session transaction.

### 6.2 On-Block Subscription

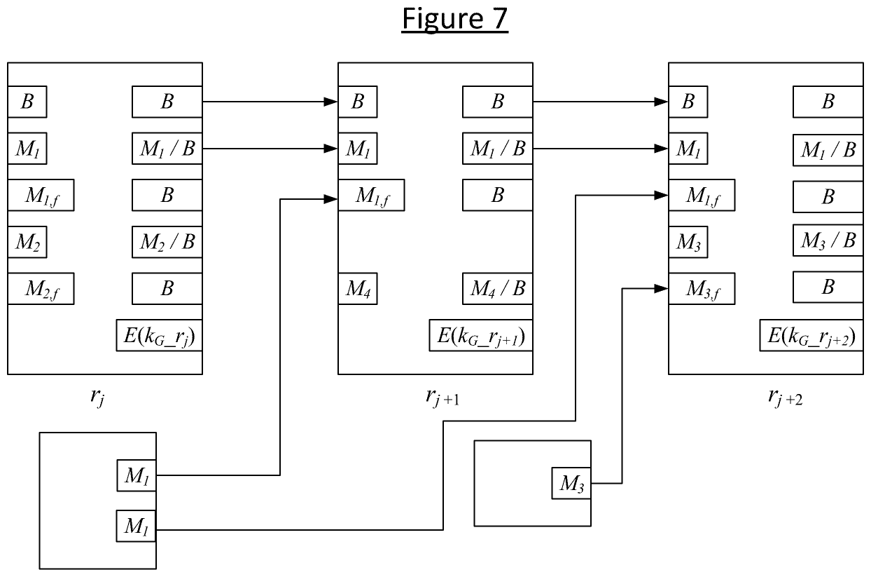

This section describes an example system where payment for the broadcast encryption is paid within the session transaction. See FIG. 7.

Once again three sessions are represented rⱼ, rⱼ₊₁, and rⱼ₊₂. Each session has a corresponding blockchain transaction Tᵣⱼ, Tᵣⱼ₊₁ and Tᵣⱼ₊₂. Each transaction has at least 2n+1 inputs and at least 2n+2 outputs, where n is the number of eligible members for that particular broadcasting session.

Similar to the off-block subscription payment, for the on-block one of the inputs of a transaction Tᵣⱼ is from the broadcaster B. However, each eligible member Mᵢ contributes to at least two inputs. One of the pair of inputs is responsible for indicating that the member gives approval of their corresponding member output (shown (visually) opposite). corresponding’ here refers to the fact that the input and output share the same index position. The second of the pair of inputs is responsible for funding the subscription to session rⱼ; its corresponding output is titled the funding output. This output would contain the amount (in coins) being paid to access the session broadcast. This funding output can also serve as replenishment for the member output, in that sufficient coins can be included to fund the mem_fee of the member output.

The locking script for the member output contains conditions that allows either the broadcaster B or the member Mᵢ to spend it, and the script operates as it previously did in the off-chain solution as presented in the previous section. For the subscription output the conditions are such that only the broadcaster (or specified authority/address) is able to spend the outputs. The coin value in the funding output must be greater than or equal to the amount required for access to broadcasted message of session rⱼ. The SIGHASH flag for each of the pair of inputs of member Mᵢ is chosen such that the ECDSA signature only signs each input's corresponding output.

Member Mᵢ spending its member output of session transaction Tᵣ as the input to session transaction Tᵣⱼ₊₁ indicates that Mᵢ is interested in having access to broadcasting session rⱼ₊₁. In addition, in order for Mᵢ to access session rⱼ₊₁ he/she must fund another input of session transaction Tᵣⱼ₊₁ with the subscription cost. The funding of this funding input can be from any UTXO belonging to Mᵢ.

On the other hand, if an Mᵢ's member output is not spent as the input to session transaction Tᵣⱼ₊₁ then this indicates that Mᵢ should not be eligible to access the broadcasting session rⱼ₊₁.

The broadcaster B again contributes an input to the session transaction, an input that is signed only after at least all the inputs and outputs of the members have been inspected and approved (as well as the OP_RETURN output included). The OP_RETURN output is created by the broadcaster B and contains the necessary rekeying content and other metadata.

### 6.2.1 Rekeying

Where the payment for eligibility is done within the session transaction, the script that locks the member output contains the same conditional statements that would enable either the broadcaster B or a member Mᵢ to spend the member output. The options are given in order that the following can be accomplished:
If a member output of session transaction Tᵣ is spent by either the broadcaster B or the member Mᵢ in a non-session transaction, this indicates that member Mᵢ's subscription to the broadcast has been revoked i.e. that member Mᵢ is not eligible for broadcast session rⱼ₊₁.
If a member output of session transaction Tᵣⱼ is spent by the member Mᵢ in a session transaction Tᵣⱼ₊₁, this indicates that the member Mᵢ has renewed its subscription in order to access the broadcast session r₁. However, note that the member must also fund the subscription with the required coins through a funding input in Tᵣⱼ₊₁. With the indication and the funding, the member is eligible for broadcast session rⱼ₊₁.

### 6.2.1.1 Rekeying: Leave

An example of a Leave for on-block funding is illustrated in FIG. 7 as the transition between session rⱼ and rⱼ₊₁. In said scenario member M₂ is deemed as not being eligible for session rⱼ₊₁.

If a member Mᵢ decides to leave after session rⱼ he/she has the responsibility of signing their member input in the session transaction Tᵣⱼ₊₁ before a time tⱼ. If after time tⱼ the member does not sign said session transaction then the broadcaster is free to consider the member Mᵢ as being ineligible for session r₁, and continue with the processes that lead to the submission of Tᵣⱼ₊₁ with the appropriate metadata in the OP_RETURN output. If before time tᵣ member Mᵢ spends their member output of Tri on a non-session transaction, this is a formal declaration by the member that they are requesting exclusion from session rⱼ₊₁. The broadcaster B can spend the output of member Mᵢ's funding output of Tᵣ₊₁ as the broadcaster sees fit, regardless of whether the member signs-up for session r₁. This is of course Mᵢ's payment for the eligibility to session rⱼ.

### 6.2.1.2 Rekeying: Join

In the case of a Join, members previously ineligible for broadcast session rⱼ, will have access to session rⱼ₊₁ granted. This is illustrated in FIG. 7 as the transition between session rⱼ₊₁ and rⱼ₊₂. In said scenario a new member M₃ (ineligible to session rⱼ₊₁) has expressed interest in being eligible for session rⱼ₊₂. That new member must provide two inputs (member and funding) and their corresponding outputs to session transaction Tᵣⱼ₊₂. The new member signs these inputs with a certified public key before time tⱼ. The session transaction Tᵣ_{ⱼ₊₂} is submitted with the appropriate rekeying metadata in the OP_RETURN output.

### 6.2.1.3 Session Transaction

Table 2 shows an example of a session transaction Tᵣ. Once again attention is placed on the sighash types. For each eligible member, their input pair, (member and funding) each of is signed using a SIGHASH_SINGLE designation. This means that the member's input signature accounts only for the output in the equivalent index as the member's input. Utilising this restriction, the member Mᵢ signs the member input of transaction as long as they are satisfied with the corresponding output script and the member signs the funding input of transaction as long as they are satisfied with the corresponding output script and coins. The member can then pass the incomplete session transaction to another member (or the broadcaster B) without any fear that any other party may alter the value and output conditions. The broadcaster is the last to sign and signs his input under the SIGHASH_ALL designation.

TABLE 2
TxIDᵣ_{ⱼ}

| Inputs | | Outputs | |
|---|---|---|---|
| Info | Script | Value | Script |
| x_{B} BSV | < Sig(P_{B})> <P_{B}> | y_{B} BSV | OP_DUP OP_HASH160 |
| SIGHASH_ALL | | | H(P_{B}) OP_EQUALVERIFY |
| | | | OP_CHECKSIG |
| ${x}_{{M}_{1 , {r}_{j}}} BSV$ SIGHASH_SINGLE | < Sig(P_{M}_{₁} )> | ${y}_{{M}_{1 , {r}_{j}}} BSV$ | OP_1 <P_{M}_{₂}> <P_{B}> OP_2 CHECKMULTISIG |
| ${x}_{{F}_{1 , {r}_{j}}} BSV$ | < Sig(P_{M}_{₁})> | ${y}_{{F}_{1 , {r}_{j}}} BSV$ | OP_DUP OP_HASH160 H(P_{B}) OP_EQUALVERIFY |
| SIGHASH_SINGLE | | | OP_CHECKSIG |
| ${x}_{{M}_{2 , {r}_{j}}} BSV$ SIGHASH_SINGLE | < Sig(P_{M}_{₂})> | ${y}_{{M}_{2 , {r}_{j}}} BSV$ | OP_1 <P_{M}_{₂}> <P_{B}> OP_2 CHECKMULTISIG |
| ${x}_{{M}_{2 , {r}_{j}}} BSV$ SIGHASH_SINGLE | < Sig(P_{M}_{₂})> | ${y}_{{F}_{2 , {r}_{j}}} BSV$ BSV | OP_DUP OP_HASH160 H (P_{B}) OP_EQUALVERIFY OP_CHECKSIG |
| . | . | . | . |
| . | . | . | . |
| . | . | . | . |
| ${x}_{{M}_{n , {r}_{j}}} BSV$ | $〈 Sig ( {P}_{{M}_{{n}_{j}}} ) 〉$ | ${y}_{{M}_{{n}_{j}} , {r}_{j}} BSV$ | $OP\_ 1 〈 {P}_{{M}_{{n}_{j}}} 〉 〈 {P}_{B} 〉 OP\_ 2$ |
| SIGHASH_SINGLE | | | CHECKMULTISIG |
| ${x}_{{M}_{{n}_{j}} , {r}_{j}} BSV$ SIGHASH_SINGLE | $〈 Sig ( {P}_{{M}_{{n}_{j}}} ) 〉$ | ${y}_{{F}_{{n}_{j}} , {r}_{j}} BSV$ | OP_DUP OP_HASH160 H (P_{B}) OP_EQUALVERIFY |
| | | | OP_CHECKSIG |
| | | ≈0BSV | OP_FALSE OP_RETURN <Re- |
| | | | keying metadata> <other metadata> |

### 6.2.1.4 Coins and Subscription

In this system a member re-subscribes for each session by signing the input of the session transaction as well as providing new funding for the session in question. Given that a member may introduce new funding for each session, this allows for
intermittent payments for the subscription for each session rather than the bulk of payment up front. (e.g., pay for each month rather than the full year)
replenishing the coins of the member output for each session.

### 6.3 Transaction Distribution

Both the on-chain and off-chain solutions have been described in terms of one transaction per session rⱼ, however in cases where there are large members sets this would be impractical. Consider a media streaming service which has millions of subscribers; having that many inputs and outputs in a transaction would be unwieldly or impossible for existing blockchain implementations.

This can be addressed by distributing the metadata (more specifically the

$$E ( {k}_{G}^{{r}_{j}} )$$

values) across multiple transactions.

$$E ( {k}_{G}^{{r}_{j}} ) ,$$

we recall, represents the entirety of the communiqués of the broadcaster. However, the communiqués that enable a secure broadcast can be different based on the key graph strategy utilised, noting of course that some communiqués are relevant to (and decipherable by) only some members while other communiqués are not. With this in mind, the session transaction rⱼ can be replaced by multiple sub-session transactions where each transaction only contains the communiqués of the relevant members, and only the relevant members are asked to sign the inputs of the sub-session transaction.

As an example, if one were to utilise the user-oriented strategy, a member is expected to find all his applicable keys in one communique and thus only one session transaction. For said example in Section 4.1 if a new subscriber member M₉ joins then there would be three rⱼ session transactions. For one transaction the required signatories are:
{M₁, . . . , M₆} and the OP_RETURN metadata would include

$$E ( {k}_{G}^{{r}_{j , 1}} ) = {\{ {k}_{1 - 9} \}}_{{k}_{1 - 8}} ,$$

for another {M₇, M₈} with metadata

$$E ( {k}_{G}^{{r}_{j , 2}} ) = {\{ {k}_{1 - 9} , {k}_{789} \}}_{{k}_{78}} ,$$

and for the third {M₉} the metadata is

$$E ( {k}_{G}^{{r}_{j , 3}} ) = {\{ {k}_{1 - 9} , {k}_{789} \}}_{{k}_{9}} .$$

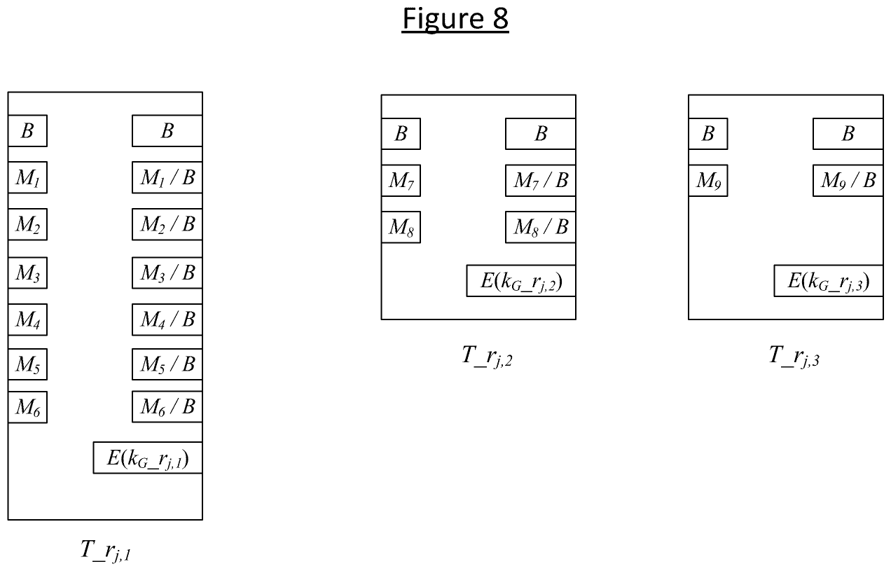

In FIG. 8, for session rⱼ, the sub-session transactions T_{rj,1}, T_{rj,2}, and T_{rj,3} are shown. This is with respect to the Join scenario of user-oriented strategy outlined in Section 4.1. As opposed to the use of a sole session transaction, for sub-session transactions, a set of members being in the same sub-session transaction of session rⱼ are not necessarily all in the same sub-session transaction of session rⱼ₊₁. The sub-session transactions that the members are a part of in session rⱼ₊₁ would be dependent on what members leave or join after session rⱼ.

In the case of the key-oriented strategy, the keys that a member needs would be distributed across multiple sub-session transactions for session rⱼ. The member would thus have to keep track of and sign multiple transactions for each session.

### 6.4 Centralisation

Broadcasting is typically associated with a central figure who is responsible for sending the variety of communiqués to the appropriate individuals. The limitation of relying on this broadcaster B is that if they are compromised or unavailable, then the entire system is compromised or unavailable.

For the examples described herein, the broadcaster is required to sign the various session transactions to certify the legitimacy of the members and their outputs, as well as to provide the OP_RETURN metadata with the applicable keys. To mitigate the dependence on the authority of one individual, the broadcaster B (more so the signature) can be seen as being the representation of a threshold of users. If they are satisfied with the content of the session transaction, then the signature can be produced using a threshold signature scheme. The broadcaster himself does not have to be the one to produce the OP_RETURN key metadata

$$E ( {k}_{G}^{{r}_{j}} ) ;$$

this could have been produced by one or more third party individuals, the broadcaster B (threshold or otherwise) only needs to approve the metadata.

### 6.5 Security Measures

Members send their signed components securely to the broadcaster. This is to prevent the inclusion of the member's signed SIGHASH_SINGLE-signed input-output to be included in a non-session transaction by a malicious actor.

If a member double-spends and the broadcaster only finds this out at the time of submission to blockchain (transaction rejected), then the malicious actor could eavesdrop and see keys of metadata

$$E ( {k}_{G}^{{r}_{j}} ) ;$$

while the transaction is being communicated to the blockchain network. The broadcaster waits until the session (or all sub-session) transactions are uploaded successfully before making the encrypted broadcast available; this gives the broadcaster an opportunity to re-encrypt the message with a different key

$${k}_{G}^{{r}_{j}}$$

if they think the system has been compromised.

### 7. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

Some embodiments have been described in terms of the blockchain network implementing a proof-of-work consensus mechanism to secure the underlying blockchain. However proof-of-work is just one type of consensus mechanism and in general embodiments may use any type of suitable consensus mechanism such as, for example, proof-of-stake, delegated proof-of-stake, proof-of-capacity, or proof-of-elapsed time. As a particular example, proof-of-stake uses a randomized process to determine which blockchain node 104 is given the opportunity to produce the next block 151. The chosen node is often referred to as a validator. Blockchain nodes can lock up their tokens for a certain time in order to have the chance of becoming a validator. Generally, the node who locks the biggest stake for the longest period of time has the best chance of becoming the next validator.

It will be appreciated that the above embodiments have been described by way of example only. More generally there may be provided a method, apparatus or program in accordance with any one or more of the following Statements.

Statement 1. A computer-implemented method of enabling users to access broadcasted messages using blockchain transactions, wherein each user is associated with a respective user encryption key, and wherein the method is performing by a broadcasting party and comprises, for a first message:
determining a first set of users eligible to access the first message;
maintaining a first key graph comprising a plurality of nodes, wherein the key graph comprises a root layer comprising a first root node, followed by one or more inner layers, each inner layer comprising a respective plurality of inner nodes, followed by a leaf layer comprising a plurality of leaf nodes, wherein the root node is a parent node of the respective plurality of inner nodes of a first one of the inner layers, wherein each node of each respective inner layer other than a final inner layer is a respective parent node of one or more respective inner nodes a next inner layer, wherein each inner node of a final one of the inner layers is a respective parent node of one or more leaf nodes of the leaf layer, wherein each node is mapped to a respective encryption key, each leaf node being mapped to a respective user encryption key of the first set of users, wherein the first root node is mapped to a first message encryption key, wherein a respective key mapped to a respective child node is used to encrypt a respective key mapped to a respective parent node;
generating a first encrypted message by encrypting the first message with the first message encryption key;
determining a first set of encrypted data items, wherein each respective encrypted data item in the first set of encrypted data items comprises one or more respective encryption keys mapped to one or more respective parent nodes of the first key graph, encrypted using a respective encrypted key mapped to a respective child node of the respective parent node of the one or more respective parent nodes of a respective lowest layer of the first key graph, wherein each respective user of the first set of users is configured to decrypt at least one of the respective encrypted data items;
obtaining a first message transaction, wherein the first message transaction comprises:
   a respective input associated with each respective user of the first set of users, wherein the respective input is signed by the respective user,
   a respective input associated with the broadcasting party, wherein the respective input is signed by the broadcasting party,
   a respective output associated with each user of the first set of users, wherein each respective output is locked to respective public key of the respective user and/or a public key of the broadcasting party, and
   a respective output comprising the first set of encrypted data items;
causing the first message transaction to be submitted to a blockchain network; and
broadcasting the first encrypted message to at least the first set of users.

Statement 2. The method of statement 1, comprising, for a second message:
determining a second set of users eligible to access the first message, wherein the second set of users comprises either i) some but not all of the first set of users, or ii) all of the first set of users and at least one further user, or iii) some but not all of the first set of users and at least one further user;
generating a second key graph by updating the first key graph, wherein said updating comprises replacing the first root node with a second root node, the second root node being mapped to a second message encryption key, and adding or removing one or more inner nodes of one or more inner levels, and adding or removing one or more leaf nodes based on whether the second set of users comprises more or fewer users than the first set of users;
generating a second encrypted message by encrypting the second message with a second message encryption key;
determining a second set of encrypted data items, wherein each respective encrypted data item in the second set of encrypted data items comprises one or more respective encryption keys mapped to one or more respective parent nodes of the second key graph, encrypted using a respective encrypted key mapped to a respective child node of the respective parent node of the one or more respective parent nodes of a respective lowest layer of the second key graph, wherein each respective user of the second set of users is configured to decrypt at least one of the respective encrypted data items;
obtaining a second message transaction, wherein the second message transaction comprises:
   a respective input associated with each respective user of the second set of users, wherein the respective input is signed by the respective user, wherein for each respective user belonging to both the first set and the second set, the respective input references the respective output of the first message transaction locked to the respective public key of the respective user;
   a respective input associated with the broadcasting party, wherein the respective input is signed by the broadcasting party,
   a respective output associated with each user of the second set of users, wherein each respective output is locked to respective public key of the respective user and/or a public key of the broadcasting party, and
   an output comprising the second set of encrypted data items;
causing the second message transaction to be submitted to a blockchain network; and
broadcasting the second encrypted message to at least the second set of users.

Statement 3. The method of statement 1, wherein said determining of the second set of users comprises:
determining that a respective user of the first set of users is ineligible to access a second message based on the respective output of the first transaction associated with the respective user being spent by an input of a respective non-message transaction and/or a predetermined period of time has passed since the first message transaction was recorded on a blockchain.

Statement 4. The method of statement 3, comprising:
for at least one respective user of the first set of users, revoking access to a second message by:
generating a respective non-message transaction, wherein the respective non-message transaction comprises a respective input that references the respective output of the first transaction associated with the respective user; and
causing the respective non-message transaction to be submitted to the blockchain network.

Statement 5. The method of any preceding statement, wherein a respective signature used to sign the respective input associated with the respective user also signs the respective output associated with the respective user.

Statement 6. The method of any preceding statement, wherein a respective signature used to sign the respective input associated with the broadcasting party also signs each respective output of the respective transaction.

Statement 7. The method of any preceding statement, wherein said obtaining of the first message transaction comprises, from each of the first set of users, receiving the respective input associated with the respective user and the respective output associated with the respective user.

Statement 8. The method of any preceding statement, wherein the first message transaction comprises:
a respective additional input associated with each respective user of the first set of users, wherein the respective additional input is signed by the respective user.

Statement 9. The method of any preceding statement, wherein the first message transaction comprises the first encrypted message.

Statement 10. The method of statement 9, wherein said broadcasting of the first encrypted message to the first set of users is performed by said causing of the first message transaction to be submitted to the blockchain network.

Statement 11. The method of any preceding statement, comprising, for the first message:
determining one or more respective additional first sets of users eligible to access the first message;
determining one or more respective additional first sets of encrypted data items, wherein each respective encrypted data item in the respective additional first set of encrypted data items comprises one or more respective encryption keys mapped to one or more respective parent nodes of the first key graph, encrypted using a respective encrypted key mapped to a respective child node of the respective parent node of the one or more respective parent nodes of a respective lowest layer of the first key graph, wherein each respective user of the respective additional first set of users is configured to decrypt at least one of the respective encrypted data items of the respective additional first set and
for each respective additional first set of encrypted data items, obtaining a respective additional first message transaction, wherein the respective additional first message transaction comprises:
   a respective input associated with each respective user of the respective additional first set of users, wherein the respective input is signed by the respective user,
   a respective input associated with the broadcasting party, wherein the respective input is signed by the broadcasting party,
   a respective output associated with each user of the respective additional first set of users, wherein each respective output is locked to respective public key of the respective user and/or a public key of the broadcasting party, and
   a respective output comprising the respective additional first set of encrypted data items; and
causing the respective additional first message transaction to be submitted to the blockchain network.

Statement 12. The method of statement 2 and statement 11, comprising, for the second message:
determining one or more respective additional second sets of users eligible to access the first message, wherein one or more of the respective additional second sets of users comprise either i) some but not all of a respective additional first set of users, or ii) all of a respective additional first set of users and at least one further user;
determining one or more respective additional second sets of encrypted data items, wherein each respective encrypted data item in the respective additional second set of encrypted data items comprises one or more respective encryption keys mapped to one or more respective parent nodes of the second key graph, encrypted using a respective encrypted key mapped to a respective child node of the respective parent node of the one or more respective parent nodes of a respective lowest layer of the second key graph, wherein each respective user of the respective additional second set of users is configured to decrypt at least one of the respective encrypted data items of the respective additional second set; and
for each respective additional second set of encrypted data items, obtaining a respective additional second message transaction, wherein the respective additional second message transaction comprises:
   a respective input associated with each respective user of the respective additional second set of users, wherein the respective input is signed by the respective user, wherein for each respective user belonging to both the respective additional first set and the respective additional second set, the respective input references the respective output of the respective additional first message transaction locked to the respective public key of the respective user,
   a respective input associated with the broadcasting party, wherein the respective input is signed by the broadcasting party,
   a respective output associated with each user of the respective additional second set of users, wherein each respective output is locked to respective public key of the respective user and/or a public key of the broadcasting party, and
   a respective output comprising the respective additional second set of encrypted data items; and
causing the respective additional second message transaction to be submitted to the blockchain network.

Statement 13. The method of any preceding statement, wherein a signature used to sign the respective input associated with the broadcasting party is a threshold signature generated by multiple parties.

Statement 14. A computer-implemented method of accessing broadcasted messages using blockchain transactions, wherein each user is associated with a respective user encryption key, wherein a broadcasting party maintains a first key graph comprising a plurality of nodes, wherein the key graph comprises a root layer comprising a first root node, followed by one or more inner layers, each inner layer comprising a respective plurality of inner nodes, followed by a leaf layer comprising a plurality of leaf nodes, wherein the root node is a parent node of the respective plurality of inner nodes of a first one of the inner layers, wherein each node of each respective inner layer other than a final inner layer is a respective parent node of one or more respective inner nodes a next inner layer, wherein each inner node of a final one of the inner layers is a respective parent node of one or more leaf nodes of the leaf layer, wherein each node is mapped to a respective encryption key, each leaf node being mapped to a respective user encryption key of the first set of users, wherein the first root node is mapped to a first message encryption key, wherein a respective key mapped to a respective child node is used to encrypt a respective key mapped to a respective parent node,
and wherein the method is performing by a first user and comprises:
   providing, to the broadcasting party, a first input of a first message transaction, wherein the first message transaction comprises a first output locked to a first public key of the first user and/or a public key of the broadcasting party, wherein the first input is signed by the first user;
   obtaining the first message transaction, wherein the first message transaction comprises an output comprising a first set of encrypted data items, wherein each respective encrypted data item in the first set of encrypted data items comprises one or more respective encryption keys mapped to one or more respective parent nodes of the first key graph, encrypted using a respective encryption key mapped to a respective child node of the respective parent node of the one or more respective parent nodes of a respective lowest layer of the first key graph,
   obtaining, from the broadcasting party, a first encrypted message generated by encrypting a first message with the first message encryption key;
   decrypting at least one of the respective encrypted data items, using the respective encryption key used to encrypt the respective encrypted data item, to obtain the one or more respective encryption keys; and
   decrypting the first encrypted message, using at least the obtained one or more respective encryption keys, to obtain the first message.

Statement 15. The method of statement 14, comprising:
providing, to the broadcasting party, one or more respective additional first inputs of one or more respective additional first message transactions, wherein the one or more respective additional first message transactions comprise a respective additional first output locked to a respective first public key of the first user and/or a respective public key of the broadcasting party, wherein the respective first input is signed by the first user;
obtaining the one or more respective additional first message transactions, wherein the respective additional first message transaction comprises a respective output comprising a respective additional first set of encrypted data items, wherein each respective encrypted data item in the respective additional first set of encrypted data items comprises one or more respective encryption keys mapped to one or more respective parent nodes of the first key graph, encrypted using a respective encryption key mapped to a respective child node of the respective parent node of the one or more respective parent nodes of a respective lowest layer of the first key graph,
decrypting one or more respective encrypted data items of one or more of the respective additional first message transactions, using the respective encryption keys used to encrypt the one or more respective encrypted data items, to obtain the one or more respective encryption keys; and
wherein said decrypting of the first encrypted message comprises using each of the obtained one or more respective encryption keys to decrypt the first encrypted message to obtain the first message.

Statement 16. The method of statement 14 or statement 15, wherein the broadcasting party maintains a second key graph generated by updating the first key graph, wherein said updating comprises replacing the first root node with a second root node, the second root node being mapped to a second message encryption key, and adding or removing one or more inner nodes of one or more inner levels, and adding or removing one or more leaf nodes based on whether the second set of users comprises more or fewer users than the first set of users, and wherein the method comprises:
providing, to the broadcasting party, a first input of a second message transaction, wherein the second message transaction comprises a first output locked to a second public key of the first user and/or a public key of the broadcasting party, wherein the first input is signed by the first user;
obtaining the second message transaction, wherein the second message transaction comprises an output comprising a second set of encrypted data items, wherein each respective encrypted data item in the second set of encrypted data items comprises one or more respective encryption keys mapped to one or more respective parent nodes of the second key graph, encrypted using a respective encryption key mapped to a respective child node of the respective parent node of the one or more respective parent nodes of a respective lowest layer of the second key graph,
obtaining, from the broadcasting party, a second encrypted message generated by encrypting a second message with the second message encryption key;
decrypting at least one of the respective encrypted data items, using the respective encryption key used to encrypt the respective encrypted data item, to obtain the one or more respective encryption keys; and
decrypting the second encrypted message, using at least the obtained one or more respective encryption keys, to obtain the second message.

Statement 17. The method of statement 14 or any statement dependent thereon, comprising:
providing, to the broadcasting party, a second input of the first message transaction, wherein the second input is signed by the first user.

Statement 18. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 17.

Statement 19. A computer program embodied on computer-readable storage and configured so as, when run on one or more processors, to perform the method of any of statements 1 to 17.

According to another aspect disclosed herein, there may be provided a method comprising the actions of the broadcasting party and the first user.

According to another aspect disclosed herein, there may be provided a system comprising the computer equipment of the broadcasting party and the first user.

1. A computer-implemented method of enabling users to access broadcasted messages using blockchain transactions, wherein each user is associated with a respective user encryption key, and wherein the method is performing by a broadcasting party and comprises, for a first message:
determining a first set of users eligible to access the first message;
maintaining a first key graph comprising a plurality of nodes, wherein the key graph comprises a root layer comprising a first root node, followed by one or more inner layers, each inner layer comprising a respective plurality of inner nodes, followed by a leaf layer comprising a plurality of leaf nodes, wherein the root node is a parent node of the respective plurality of inner nodes of a first one of the inner layers, wherein each node of each respective inner layer other than a final inner layer is a respective parent node of one or more respective inner nodes a next inner layer, wherein each inner node of a final one of the inner layers is a respective parent node of one or more leaf nodes of the leaf layer, wherein each node is mapped to a respective encryption key, each leaf node being mapped to a respective user encryption key of the first set of users, wherein the first root node is mapped to a first message encryption key, wherein a respective key mapped to a respective child node is used to encrypt a respective key mapped to a respective parent node;
generating a first encrypted message by encrypting the first message with the first message encryption key;
determining a first set of encrypted data items, wherein each respective encrypted data item in the first set of encrypted data items comprises one or more respective encryption keys mapped to one or more respective parent nodes of the first key graph, encrypted using a respective encrypted key mapped to a respective child node of the respective parent node of the one or more respective parent nodes of a respective lowest layer of the first key graph, wherein each respective user of the first set of users is configured to decrypt at least one of the respective encrypted data items;
obtaining a first message transaction, wherein the first message transaction comprises:
a respective input associated with each respective user of the first set of users, wherein the respective input is signed by the respective user,
a respective input associated with the broadcasting party, wherein the respective input is signed by the broadcasting party,
a respective output associated with each user of the first set of users, wherein each respective output is locked to respective public key of the respective user and/or a public key of the broadcasting party, and
a respective output comprising the first set of encrypted data items;
causing the first message transaction to be submitted to a blockchain network; and
broadcasting the first encrypted message to at least the first set of users.

2. The method of claim 1, comprising, for a second message:
determining a second set of users eligible to access the first message, wherein the second set of users comprises either i) some but not all of the first set of users, or ii) all of the first set of users and at least one further user, or iii) some but not all of the first set of users and at least one further user;
generating a second key graph by updating the first key graph, wherein said updating comprises replacing the first root node with a second root node, the second root node being mapped to a second message encryption key, and adding or removing one or more inner nodes of one or more inner levels, and adding or removing one or more leaf nodes based on whether the second set of users comprises more or fewer users than the first set of users;
generating a second encrypted message by encrypting the second message with a second message encryption key;
determining a second set of encrypted data items, wherein each respective encrypted data item in the second set of encrypted data items comprises one or more respective encryption keys mapped to one or more respective parent nodes of the second key graph, encrypted using a respective encrypted key mapped to a respective child node of the respective parent node of the one or more respective parent nodes of a respective lowest layer of the second key graph, wherein each respective user of the second set of users is configured to decrypt at least one of the respective encrypted data items;
obtaining a second message transaction, wherein the second message transaction comprises:
a respective input associated with each respective user of the second set of users, wherein the respective input is signed by the respective user, wherein for each respective user belonging to both the first set and the second set, the respective input references the respective output of the first message transaction locked to the respective public key of the respective user;
a respective input associated with the broadcasting party, wherein the respective input is signed by the broadcasting party,
a respective output associated with each user of the second set of users, wherein each respective output is locked to respective public key of the respective user and/or a public key of the broadcasting party, and
an output comprising the second set of encrypted data items;
causing the second message transaction to be submitted to a blockchain network; and
broadcasting the second encrypted message to at least the second set of users.

3. The method of claim 2, wherein said determining of the second set of users comprises:
determining that a respective user of the first set of users is ineligible to access a second message based on the respective output of the first transaction associated with the respective user being spent by an input of a respective non-message transaction and/or a predetermined period of time has passed since the first message transaction was recorded on a blockchain.

4. The method of claim 3, comprising:
for at least one respective user of the first set of users, revoking access to a second message by;
generating a respective non-message transaction, wherein the respective non-message transaction comprises a respective input that references the respective output of the first transaction associated with the respective user; and
causing the respective non-message transaction to be submitted to the blockchain network.

5. The method of claim 1, wherein a respective signature used to sign the respective input associated with the respective user also signs the respective output associated with the respective user.

6. The method of claim 1, wherein a respective signature used to sign the respective input associated with the broadcasting party also signs each respective output of the respective transaction.

7. The method of claim 1, wherein said obtaining of the first message transaction comprises, from each of the first set of users, receiving the respective input associated with the respective user and the respective output associated with the respective user.

8. The method of claim 1, wherein the first message transaction comprises:
a respective additional input associated with each respective user of the first set of users, wherein the respective additional input is signed by the respective user.

9. The method of claim 1, wherein the first message transaction comprises the first encrypted message.

10. The method of claim 9, wherein said broadcasting of the first encrypted message to the first set of users is performed by said causing of the first message transaction to be submitted to the blockchain network.

11. The method of claim 1, comprising, for the first message:
determining one or more respective additional first sets of users eligible to access the first message;
determining one or more respective additional first sets of encrypted data items, wherein each respective encrypted data item in the respective additional first set of encrypted data items comprises one or more respective encryption keys mapped to one or more respective parent nodes of the first key graph, encrypted using a respective encrypted key mapped to a respective child node of the respective parent node of the one or more respective parent nodes of a respective lowest layer of the first key graph, wherein each respective user of the respective additional first set of users is configured to decrypt at least one of the respective encrypted data items of the respective additional first set and
for each respective additional first set of encrypted data items, obtaining a respective additional first message transaction, wherein the respective additional first message transaction comprises:
a respective input associated with each respective user of the respective additional first set of users, wherein the respective input is signed by the respective user,
a respective input associated with the broadcasting party, wherein the respective input is signed by the broadcasting party,
a respective output associated with each user of the respective additional first set of users, wherein each respective output is locked to respective public key of the respective user and/or a public key of the broadcasting party, and
a respective output comprising the respective additional first set of encrypted data items; and
causing the respective additional first message transaction to be submitted to the blockchain network.

12. The method of claim 2, comprising:
i) for the first message;
determining one or more respective additional first sets of users eligible to access the first message;
determining one or more respective additional first sets of encrypted data items, wherein each respective encrypted data item in the respective additional first set of encrypted data items comprises one or more respective encryption keys mapped to one or more respective parent nodes of the first key graph, encrypted using a respective encrypted key mapped to a respective child node of the respective parent node of the one or more respective parent nodes of a respective lowest layer of the first key graph, wherein each respective user of the respective additional first set of users is configured to decrypt at least one of the respective encrypted data items of the respective additional first set and
for each respective additional first set of encrypted data items, obtaining a respective additional first message transaction, wherein the respective additional first message transaction comprises:
a respective input associated with each respective user of the respective additional first set of users, wherein the respective input is signed by the respective user,
a respective input associated with the broadcasting party, wherein the respective input is signed by the broadcasting party,
a respective output associated with each user of the respective additional first set of users, wherein each respective output is locked to respective public key of the respective user and/or a public key of the broadcasting party, and
a respective output comprising the respective additional first set of encrypted data items; and
causing the respective additional first message transaction to be submitted to the blockchain network; and
ii) for the second message;
determining one or more respective additional second sets of users eligible to access the first message, wherein one or more of the respective additional second sets of users comprise either i) some but not all of a respective additional first set of users, or ii) all of a respective additional first set of users and at least one further user;
determining one or more respective additional second sets of encrypted data items, wherein each respective encrypted data item in the respective additional second set of encrypted data items comprises one or more respective encryption keys mapped to one or more respective parent nodes of the second key graph, encrypted using a respective encrypted key mapped to a respective child node of the respective parent node of the one or more respective parent nodes of a respective lowest layer of the second key graph, wherein each respective user of the respective additional second set of users is configured to decrypt at least one of the respective encrypted data items of the respective additional second set; and
for each respective additional second set of encrypted data items, obtaining a respective additional second message transaction, wherein the respective additional second message transaction comprises:
a respective input associated with each respective user of the respective additional second set of users, wherein the respective input is signed by the respective user, wherein for each respective user belonging to both the respective additional first set and the respective additional second set, the respective input references the respective output of the respective additional first message transaction locked to the respective public key of the respective user,
a respective input associated with the broadcasting party, wherein the respective input is signed by the broadcasting party,
a respective output associated with each user of the respective additional second set of users, wherein each respective output is locked to respective public key of the respective user and/or a public key of the broadcasting party, and
a respective output comprising the respective additional second set of encrypted data items; and
causing the respective additional second message transaction to be submitted to the blockchain network.

13. The method of claim 1, wherein a signature used to sign the respective input associated with the broadcasting party is a threshold signature generated by multiple parties.

14. A computer-implemented method of accessing broadcasted messages using blockchain transactions, wherein each user is associated with a respective user encryption key, wherein a broadcasting party maintains a first key graph comprising a plurality of nodes, wherein the key graph comprises a root layer comprising a first root node, followed by one or more inner layers, each inner layer comprising a respective plurality of inner nodes, followed by a leaf layer comprising a plurality of leaf nodes, wherein the root node is a parent node of the respective plurality of inner nodes of a first one of the inner layers, wherein each node of each respective inner layer other than a final inner layer is a respective parent node of one or more respective inner nodes a next inner layer, wherein each inner node of a final one of the inner layers is a respective parent node of one or more leaf nodes of the leaf layer, wherein each node is mapped to a respective encryption key, each leaf node being mapped to a respective user encryption key of a first set of users, wherein the first root node is mapped to a first message encryption key, wherein a respective key mapped to a respective child node is used to encrypt a respective key mapped to a respective parent node,
and wherein the method is performing by a first user and comprises:
providing, to the broadcasting party, a first input of a first message transaction, wherein the first message transaction comprises a first output locked to a first public key of the first user and/or a public key of the broadcasting party, wherein the first input is signed by the first user;
obtaining the first message transaction, wherein the first message transaction comprises an output comprising a first set of encrypted data items, wherein each respective encrypted data item in the first set of encrypted data items comprises one or more respective encryption keys mapped to one or more respective parent nodes of the first key graph, encrypted using a respective encryption key mapped to a respective child node of the respective parent node of the one or more respective parent nodes of a respective lowest layer of the first key graph,
obtaining, from the broadcasting party, a first encrypted message generated by encrypting a first message with the first message encryption key;
decrypting at least one of the respective encrypted data items, using the respective encryption key used to encrypt the respective encrypted data item, to obtain the one or more respective encryption keys; and
decrypting the first encrypted message, using at least the obtained one or more respective encryption keys, to obtain the first message.

15. The method of claim 14, comprising:
providing, to the broadcasting party, one or more respective additional first inputs of one or more respective additional first message transactions, wherein the one or more respective additional first message transactions comprise a respective additional first output locked to a respective first public key of the first user and/or a respective public key of the broadcasting party, wherein the respective first input is signed by the first user;
obtaining the one or more respective additional first message transactions, wherein the respective additional first message transaction comprises a respective output comprising a respective additional first set of encrypted data items, wherein each respective encrypted data item in the respective additional first set of encrypted data items comprises one or more respective encryption keys mapped to one or more respective parent nodes of the first key graph, encrypted using a respective encryption key mapped to a respective child node of the respective parent node of the one or more respective parent nodes of a respective lowest layer of the first key graph,
decrypting one or more respective encrypted data items of one or more of the respective additional first message transactions, using the respective encryption keys used to encrypt the one or more respective encrypted data items, to obtain the one or more respective encryption keys; and
wherein said decrypting of the first encrypted message comprises using each of the obtained one or more respective encryption keys to decrypt the first encrypted message to obtain the first message.

16. The method of claim 14, wherein the broadcasting party maintains a second key graph generated by updating the first key graph, wherein said updating comprises replacing the first root node with a second root node, the second root node being mapped to a second message encryption key, and adding or removing one or more inner nodes of one or more inner levels, and adding or removing one or more leaf nodes based on whether a second set of users comprises more or fewer users than the first set of users, and wherein the method comprises:
providing, to the broadcasting party, a first input of a second message transaction, wherein the second message transaction comprises a first output locked to a second public key of the first user and/or a public key of the broadcasting party, wherein the first input is signed by the first user;
obtaining the second message transaction, wherein the second message transaction comprises an output comprising a second set of encrypted data items, wherein each respective encrypted data item in the second set of encrypted data items comprises one or more respective encryption keys mapped to one or more respective parent nodes of the second key graph, encrypted using a respective encryption key mapped to a respective child node of the respective parent node of the one or more respective parent nodes of a respective lowest layer of the second key graph,
obtaining, from the broadcasting party, a second encrypted message generated by encrypting a second message with the second message encryption key;
decrypting at least one of the respective encrypted data items, using the respective encryption key used to encrypt the respective encrypted data item, to obtain the one or more respective encryption keys; and
decrypting the second encrypted message, using at least the obtained one or more respective encryption keys, to obtain the second message.

17. The method of claim 14, comprising:
providing, to the broadcasting party, a second input of the first message transaction, wherein the second input is signed by the first user.

18. Computer equipment comprising:
memory comprising one or more memory units; and
processing apparatus comprising one or more processing units, wherein the memory stores code arranged to run on the processing apparatus, the code being configured so as when on the processing apparatus to perform a method of enabling users to access broadcasted messages using blockchain transactions, wherein each user is associated with a respective user encryption key, and wherein the method is performing by a broadcasting party and comprises, for a first message;
determining a first set of users eligible to access the first message;
maintaining a first key graph comprising a plurality of nodes, wherein the key graph comprises a root layer comprising a first root node, followed by one or more inner layers, each inner layer comprising a respective plurality of inner nodes, followed by a leaf layer comprising a plurality of leaf nodes, wherein the root node is a parent node of the respective plurality of inner nodes of a first one of the inner layers, wherein each node of each respective inner layer other than a final inner layer is a respective parent node of one or more respective inner nodes a next inner layer, wherein each inner node of a final one of the inner layers is a respective parent node of one or more leaf nodes of the leaf layer, wherein each node is mapped to a respective encryption key, each leaf node being mapped to a respective user encryption key of the first set of users, wherein the first root node is mapped to a first message encryption key, wherein a respective key mapped to a respective child node is used to encrypt a respective key mapped to a respective parent node;
generating a first encrypted message by encrypting the first message with the first message encryption key;
determining a first set of encrypted data items, wherein each respective encrypted data item in the first set of encrypted data items comprises one or more respective encryption keys mapped to one or more respective parent nodes of the first key graph, encrypted using a respective encrypted key mapped to a respective child node of the respective parent node of the one or more respective parent nodes of a respective lowest layer of the first key graph, wherein each respective user of the first set of users is configured to decrypt at least one of the respective encrypted data items;
obtaining a first message transaction, wherein the first message transaction comprises:
a respective input associated with each respective user of the first set of users, wherein the respective input is signed by the respective user,
a respective input associated with the broadcasting party, wherein the respective input is signed by the broadcasting party,
a respective output associated with each user of the first set of users, wherein each respective output is locked to respective public key of the respective user and/or a public key of the broadcasting party, and
a respective output comprising the first set of encrypted data items;
causing the first message transaction to be submitted to a blockchain network; and
broadcasting the first encrypted message to at least the first set of users.

19. A non-transitory computer-readable storage medium comprising computer program code configured so as, when run on one or more processors, the one or more processors perform a method of enabling users to access broadcasted messages using blockchain transactions, wherein each user is associated with a respective user encryption key, and wherein the method is performing by a broadcasting party and comprises, for a first message:
determining a first set of users eligible to access the first message;
maintaining a first key graph comprising a plurality of nodes, wherein the key graph comprises a root layer comprising a first root node, followed by one or more inner layers, each inner layer comprising a respective plurality of inner nodes, followed by a leaf layer comprising a plurality of leaf nodes, wherein the root node is a parent node of the respective plurality of inner nodes of a first one of the inner layers, wherein each node of each respective inner layer other than a final inner layer is a respective parent node of one or more respective inner nodes a next inner layer, wherein each inner node of a final one of the inner layers is a respective parent node of one or more leaf nodes of the leaf layer, wherein each node is mapped to a respective encryption key, each leaf node being mapped to a respective user encryption key of the first set of users, wherein the first root node is mapped to a first message encryption key, wherein a respective key mapped to a respective child node is used to encrypt a respective key mapped to a respective parent node;
generating a first encrypted message by encrypting the first message with the first message encryption key;
determining a first set of encrypted data items, wherein each respective encrypted data item in the first set of encrypted data items comprises one or more respective encryption keys mapped to one or more respective parent nodes of the first key graph, encrypted using a respective encrypted key mapped to a respective child node of the respective parent node of the one or more respective parent nodes of a respective lowest layer of the first key graph, wherein each respective user of the first set of users is configured to decrypt at least one of the respective encrypted data items;
obtaining a first message transaction, wherein the first message transaction comprises:
a respective input associated with each respective user of the first set of users, wherein the respective input is signed by the respective user,
a respective input associated with the broadcasting party, wherein the respective input is signed by the broadcasting party,
a respective output associated with each user of the first set of users, wherein each respective output is locked to respective public key of the respective user and/or a public key of the broadcasting party, and
a respective output comprising the first set of encrypted data items;
causing the first message transaction to be submitted to a blockchain network; and
broadcasting the first encrypted message to at least the first set of users.
